(19) United States
(12) Patent Application Publication
(10) Pub. No.: US 2025/0051134 A1
(43) Pub. Date: Feb. 13, 2025

(54) METHOD AND ARRANGEMENT FOR MONITORING ELEVATOR SUSPENSION ROPE CONDITION

(71) Applicant: Kone Corporation, Helsinki (FI)

(72) Inventors: Juha HELENIUS, Helsinki (FI); Otto LANZ, Helsinki (FI)

(73) Assignee: Kone Corporation, Helsinki (FI)

(21) Appl. No.: 18/933,262

(22) Filed: Oct. 31, 2024

Related U.S. Application Data
(63) Continuation of application No. PCT/EP2022/067122, filed on Jun. 23, 2022.

(51) Int. Cl. B66B 7/12; B66B 1/34; B66B 5/00

(52) U.S. Cl. CPC B66B 7/1215; B66B 1/3492; B66B 5/005

(57) ABSTRACT

A method for monitoring elevator suspension rope condition, the elevator comprising: a car; a hoisting machinery with a motor, a traction sheave and a machine brake; one or more suspension ropes; and a counterweight; the car and the counterweight being suspended by said one or more ropes which are guided over a unitary traction sheave or a group of rotatable individual wheels comprised by the traction sheave for moving the car vertically in an elevator shaft; the method comprising a) performing consecutive first and second measurement steps, wherein in the first measurement step: parking the car to a first position in the shaft, in which position a total rope force on car side is selected different from a total rope force on counterweight side, and locking the car vertically immobile in place relative the shaft; enabling the traction sheave or one of the individual wheels to rotate to the direction of larger rope force; recording a first rotation angle difference (Δφ1) of the traction sheave or said one individual wheel; and in the second measurement step: parking the car to a second position in the shaft, in which position a total rope force on car side is selected different from total rope force on counterweight side, and locking the car vertically immobile in place relative the shaft; enabling the traction sheave or said one individual wheel to rotate to the direction of larger rope force; recording a second rotation angle difference (Δφ2) of the traction sheave or said one individual wheel; and b) calculating the rope stiffness based on at least said first and second measurements in at least two different vertical positions; c) indicating rope condition based on changed rope stiffness. An arrangement for monitoring elevator suspension rope condition.

### CROSS-REFERENCE TO RELATED APPLICATION

This application is a continuation of PCT International Application No. PCT/EP2022/067122 which has an International filing date of Jun. 23, 2022, the entire contents of which are incorporated herein by reference.

### FIELD OF THE INVENTION

The invention relates to condition monitoring of elevator suspension ropes. The elevator is preferably an elevator for transporting passengers and/or goods.

### BACKGROUND OF THE INVENTION

An elevator may comprise a car, a shaft, hoisting machinery, suspension ropes, and a counterweight. A separate or an integrated car frame may surround the car.

The hoisting machinery may be positioned in a shaft. The hoisting machinery may comprise a drive, an electric motor, a traction sheave, and a machinery brake. The hoisting machinery may move the car upwards and downwards in the shaft. The machinery brake may stop the rotation of the traction sheave and thereby the movement of the elevator car.

The car frame may be connected by the ropes via the traction sheave to the counterweight. The car frame may further be supported with guide members at guide rails extending in the vertical direction in the shaft. The guide rails may be attached with fastening brackets to the side wall structures in the shaft. The guide members keep the car in position in the horizontal plane when the car moves upwards and downwards in the shaft. The counterweight may be supported in a corresponding way on guide rails that are attached to the wall structure of the shaft.

The car may transport people and/or goods between the landings in the building. The wall structure of the shaft may be formed of solid walls or of an open beam structure or of any combination of these.

Elevator suspension ropes have a limited lifetime due to wire breaks, rust, and wear.

There is a demand for reliable rope condition monitoring.

### SUMMARY OF THE INVENTION

An object of the present invention is to introduce an improved method and arrangement for condition monitoring of elevator suspension ropes.

A rope condition monitoring method will be described based on stiffness measurement of elevator suspension, and relation between rope stiffness and lifetime. The stiffness measurement utilizes car parking brake or safety gear, and elevator unbalance between the car and the counterweight. Reduction of rope stiffness indicates increasing amount of wire breaks, which is a measure of rope condition and remaining lifetime.

The method for monitoring elevator suspension rope condition according to the invention is defined in independent claim 1, wherein the elevator comprises
a car; a hoisting machinery with a motor, a traction sheave, and a machine brake; one or more suspension ropes; and a counterweight;
the car and the counterweight being suspended by said one or more ropes which are guided over a unitary traction sheave or a group of rotatable individual wheels comprised by the traction sheave for moving the car vertically in an elevator shaft;
the method comprising
a) performing consecutive first and second measurement steps, wherein in the first measurement step:
parking the car to a first position in the shaft, in which position a total rope force on car side is selected different from a total rope force on counterweight side, and locking the car vertically immobile in place relative the shaft;
enabling the traction sheave or one of the individual wheels to rotate to the direction of larger rope force;
recording a first rotation angle difference of the traction sheave or said one individual wheel; and
in the second measurement step:
parking the car to a second position in the shaft, in which position a total rope force on car side is selected different from total rope force on counterweight side, and locking the car vertically immobile in place relative the shaft;
enabling the traction sheave or said one individual wheel to rotate to the direction of larger rope force;
recording a second rotation angle difference of the traction sheave or said one individual wheel; and
b) calculating the rope stiffness based on at least said first and second measurements in at least two different vertical positions;
c) indicating rope condition based on changed rope stiffness.

Preferable further details of the method are introduced in the following, which further details can be combined with the arrangement defined in independent claim 1, individually or in any combination.

In a preferred embodiment, the stiffness measurement is performed automatically.

In a preferred embodiment, the method is programmed as a sequence in an elevator control system.

In a preferred embodiment, the method comprises predicting remaining rope lifetime based on changed rope stiffness.

In a preferred embodiment, the method comprises indicating need for replacing the ropes or the rope on one said individual wheel based on decreased rope stiffness.

In a preferred embodiment, the method comprises indicating limited rope condition based on decreased rope stiffness, preferably compared to the rope stiffness during a usage phase of the ropes, more preferably when the rope stiffness has decreased by 10% compared to the usage phase.

In a preferred embodiment, the elevator comprises means for counting rope bends such as a bending counter, the method comprising indicating rope deterioration when rope stiffness with respect to rope bends decreases, preferably when a slope of a rope stiffness curve has been negative for 50 000 rope bends.

In a preferred embodiment, the method comprises performing said first and second measurements and calculation to obtain the rope stiffness regularly, preferably once a week.

In a preferred embodiment, the method comprises performing the parking of the car by closing a parking brake of the car.

In a preferred embodiment, the method comprises performing the parking of the car by closing a safety gear in the car.

In a preferred embodiment, the method comprises performing the enabling the traction sheave to rotate by opening the machine brake.

In a preferred embodiment, the first position in the shaft is a landing.

In a preferred embodiment, the second position in the shaft is a different landing from the landing in the first position.

In a preferred embodiment, the second position in the shaft differs vertically from the first position.

In a preferred embodiment, the first position in the shaft is the top landing.

In a preferred embodiment, the first position in the shaft is the bottom landing.

In a preferred embodiment, the first measurement is performed while the car is parked in the bottom landing and the second measurement is performed while the car is parked in the top landing, or respectively, the first measurement is performed while the car is parked in the top landing and the second measurement is performed while the car is parked in the bottom landing.

In a preferred embodiment, the method comprises at least one further measurement step:
parking the car to a further position in the shaft, in which position a total rope force on car side is selected different from total rope force on counterweight side, and locking the car vertically immobile in place relative the shaft;
enabling the traction sheave or one said individual wheel to rotate to the direction of larger rope force;
recording a further rotation angle difference of the traction sheave or said one individual wheel;
calculating the rope stiffness based on the measurements on different vertical positions.

In a preferred embodiment, the further position in the shaft is a landing.

In a preferred embodiment, the method comprises performing a series of measurements steps across the whole travel height of the car e.g. in 5 m steps.

In a preferred embodiment, the method comprises recording the first and second rotation angle difference by an elevator sensor such as a car encoder or a motor encoder.

In a preferred embodiment, the method comprises recording the car position by an elevator sensor such as a car encoder or a motor encoder or unique magnets per landing or unique RFID tags per landing.

In a preferred embodiment, the method comprises obtaining the rope stiffness EA from equations:

$$[ \begin{matrix}{C}_{1} \\ {C}_{2}\end{matrix} ] = \frac{R}{Δ {Fr}^{2} ( {L}_{1} - {L}_{2} )} [ \begin{matrix}- {L}_{2} & {L}_{1} \\ 1 & - 1\end{matrix} ] [ \begin{matrix}{Δφ}_{1} \\ {Δφ}_{2}\end{matrix} ]$$

where
C₁ is the combined elasticity of springs in the elevator system (rope fixing springs, motor fixing, platform springs)
C₂ is the elasticity of ropes
R is the traction sheave radius
ΔF is the change in total suspension rope force on car side after opening the machine brake
r is reeving ratio, and

$$EA = \frac{1}{{C}_{2} {rn}_{sr}} ,$$

where nₛᵣ is the amount of suspension ropes.

The arrangement for monitoring elevator suspension rope condition according to the invention is defined in independent claim 15, comprising
an elevator comprising a car; a hoisting machinery with a motor, a traction sheave, and a machine brake; one or more suspension ropes; and a counterweight;
the car and the counterweight being suspended by said one or more ropes which are guided over a unitary traction sheave or a group of rotatable individual wheels comprised by the traction sheave for moving the car vertically in an elevator shaft;
the arrangement further comprising means for
a) performing consecutive first and second measurement steps, wherein in the first measurement step:
the car is parked to a first position in the shaft, in which position a total rope force on car side is selected different from a total rope force on counterweight side, and the car is locked vertically immobile in place relative the shaft;
the traction sheave or the individual wheel is enabled to rotate to the direction of larger rope force;
a first rotation angle difference of the traction sheave or one said individual wheel is recorded; and
in the second measurement step:
the car is parked to a second position in the shaft, in which position a total rope force on car side is selected different from total rope force on counterweight side, and the car is locked vertically immobile in place relative the shaft;
the traction sheave or said one individual wheel is enabled to rotate to the direction of larger rope force;
a second rotation angle difference of the traction sheave or said one individual wheel is recorded; and
b) calculating the rope stiffness based on at least said first and second measurements in at least two different vertical positions;
c) indicating rope condition based on changed rope stiffness.

Preferable further details of the arrangement are introduced in the following, which further details can be combined with the arrangement defined in independent claim 15, individually or in any combination.

In a preferred embodiment, the arrangement comprises means for indicating need for replacing the ropes or the rope on one said individual wheel based on decreased rope stiffness.

In a preferred embodiment, the arrangement comprises means for indicating limited rope condition based on decreased rope stiffness.

In a preferred embodiment, the elevator comprises means for counting rope bends such as a bending counter, and for indicating rope deterioration when rope stiffness with respect to rope bends decreases.

In a preferred embodiment, the elevator comprises a parking brake in the car for locking the car vertically immobile.

In a preferred embodiment, the elevator comprises a safety gear in the car for locking the car vertically immobile.

In a preferred embodiment, the first position in the shaft is a landing.

In a preferred embodiment, the second position in the shaft differs vertically from the first position.

In a preferred embodiment, the arrangement comprises an elevator sensor such as a car encoder or a motor encoder for recording the first and second rotation angle difference.

In a preferred embodiment, the arrangement comprises an elevator sensor such as a car encoder or a motor encoder or unique magnets per landing or unique RFID tags per landing for recording the car position.

In a preferred embodiment, the ropes are configured to stay in place relative to the traction wheel during the measurement steps.

The method and the arrangement described provide a simple and reliable rope condition monitoring.

It has been found that an increasing amount of wire breaks is a measure of rope condition and remaining lifetime.

It has been found that failure modes depend on the rope type and can also be elevator specific. There are discharging criteria for each rope type, which may be related e.g. to the amount of wire breaks or to the residual strength of the rope. For example, according to ASME A17.1-2010, Safety Code for Elevators and Escalators, the residual strength of ropes shall not be less than 60% of the rated minimum breaking load.

The invention provides rope condition monitoring capable of predicting the remaining lifetime and optionally giving a signal when it is time to replace the ropes.

### BRIEF DESCRIPTION OF THE DRAWINGS

The invention will in the following be described in greater detail by means of preferred embodiments with reference to the attached drawings, in which:

FIG. 1 shows a side view of an elevator,

FIG. 2 shows a first arrangement for elevator suspension rope condition monitoring with 1:1 roping,

FIG. 3 shows the first arrangement with closed parking brake or safety gear,

FIG. 4 shows the first arrangement with vertically immobile car and with opened machine brake,

FIG. 5 shows a second arrangement for elevator suspension rope condition monitoring with 2:1 roping,

FIG. 6 shows the second arrangement with closed parking brake or safety gear,

FIG. 7 shows the second arrangement with vertically immobile car and with opened machine brake,

FIG. 8 shows rope stiffness as a function of bends; and

FIG. 9 shows derivative of rope stiffness with respect to bends as a function of bends.

### DETAILED DESCRIPTION

In the present figures, the elevator, and the arrangement are not shown to scale, but the figures are schematic, illustrating the basic structure and operation of the preferred embodiments. In this case, the components indicated by reference numerals in the accompanying figures correspond to the components indicated by reference numerals in this specification.

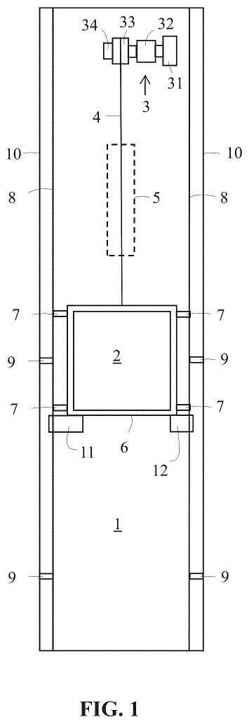

FIG. 1 shows the arrangement comprising the elevator with a car 2, a shaft 1, a hoisting machinery 3, suspension ropes 4, and a counterweight 5. A separate or an integrated car frame 6 also called as a sling may surround the car.

The hoisting machinery 3 may be positioned in the shaft 1. The hoisting machinery may comprise a drive 31, an electric motor 32, a traction sheave 33, and a machine brake 34. The hoisting machinery may move the car upwards and downwards in the shaft. The machine brake 34 may stop the rotation of the traction sheave 33 and thereby the movement of the elevator car 2.

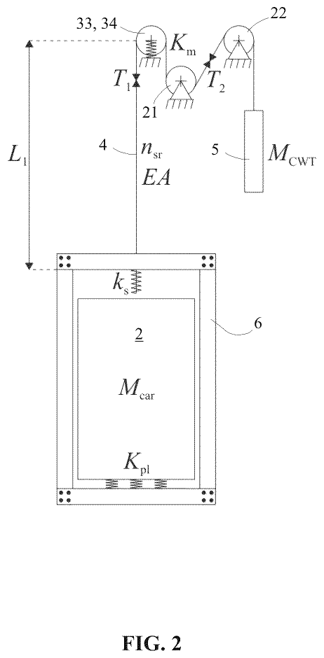

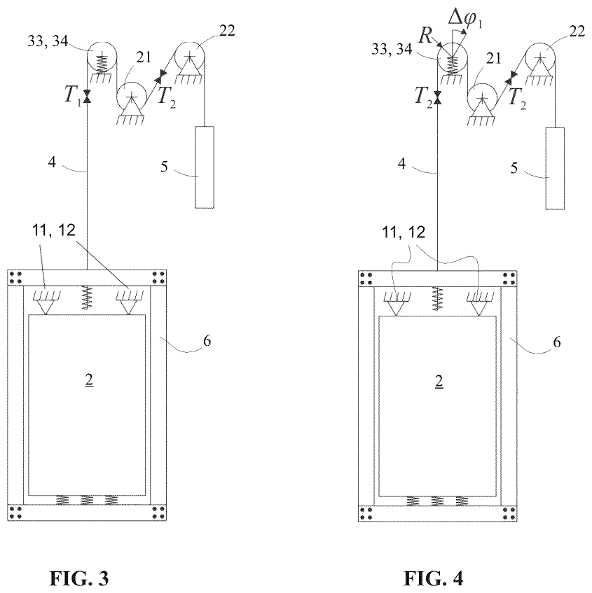

In FIGS. 2 to 4, the car frame 6 is connected by the ropes 4 via the traction sheave 33 and a first diverting pulley 21 and a second diverting pulley 22 to the counterweight 5.

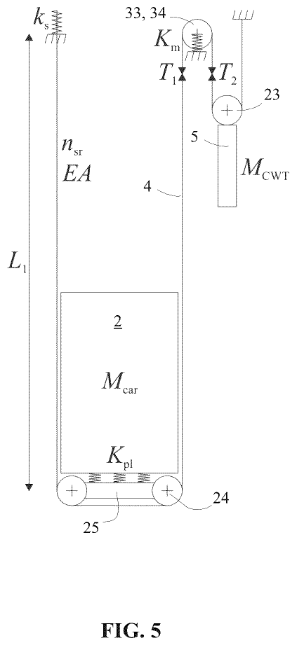

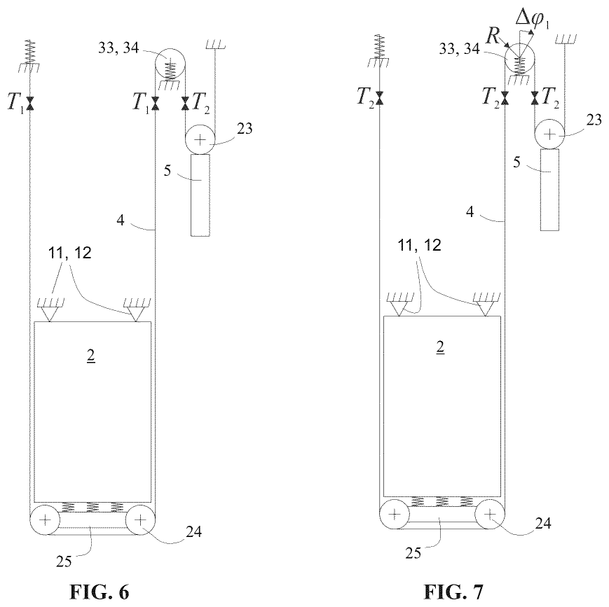

In FIGS. 5 to 7, the car frame 6 is connected by the ropes 4 via the traction sheave 33 and a counterweight pulley 23 to the counterweight 5. The ropes 4 support the car 2 via car pulleys 24. The car pulleys may be attached to a pulley beam 25 attached to the car 2.

The car and the counterweight are suspended by one or more ropes 4 which are guided over a unitary traction sheave 33 or a group of rotatable individual wheels comprised by the traction sheave for moving the car 2 vertically in the shaft 1.

The car frame 6 is further supported with guide members 7 at guide rails 8 extending in the vertical direction in the shaft. The guide rails may be attached with fastening brackets 9 to the side wall structures 10 in the shaft. The guide members 7 ensure the vertical movement of the car 2 when the car moves upwards and downwards in the shaft 1. The counterweight 5 may be supported in a corresponding way on guide rails that are attached to the wall structure of the shaft.

A safety gear 11 may be connected to the car frame 6 and to an overspeed governor rope extending vertically in the shaft 1. An automatic safety gear trigger may be attached to the car 2. The automatic safety gear trigger engages the safety gear 11 automatically in the event of hoist rope failure or manually when it is necessary to secure the car immobile in place relative the shaft 1. The safety gear 11 engages mechanically the guide rail 8 when used.

In some embodiments a parking brake 12 (car brake 12) is attached to the car 2. The car brake 12 may be used to lock the car for the following reasons: the car brake 12 may be designed for a much higher number of cycles than the safety gear 11; the safety gear is a safety device used in emergency situations; with the car brake 12, the measurement can be made with an empty car 2, as the car brake 12 holds the load in both directions; as a rule, a full car should be used with the safety gear 11, unless the safety gear 11 is two-way; and car brake 12 can be activated electronically.

The automatic safety gear trigger has an electrical contact which is part of the safety chain of the elevator, and a mechanical linkage to the car safety gear by the overspeed governor rope.

The rope condition monitoring method comprises:
a) performing consecutive first and second measurement steps, wherein in the first measurement step:
parking the car 2 to a first position L1 (rope length L1 when the car is in first position) in the shaft 1, in which position a total rope force on car side T1 is selected different from a total rope force on counterweight side T2 (car 2 load must be different from elevator balance load so that T1≠T2), and locking the car vertically immobile in place relative the shaft;
enabling the traction sheave 33 or one of the individual wheels to rotate to the direction of larger rope force T1, T2, wherein the traction sheave can rotate to the direction of larger rope force due to the unbalance and elasticity of the system;
recording a first rotation angle difference Δφ1 of the traction sheave 33 or said one individual wheel; and
thereafter the measurement is repeated in another position in the second measurement step:
parking the car 2 to a second position L2 (rope length L2 when the car in in second position) in the shaft 1, in which position a total rope force on car side T1 is selected different from total rope force on counterweight side T2, and locking the car vertically immobile in place relative the shaft;
enabling the traction sheave 33 or said one individual wheel to rotate to the direction of larger rope force T1, T2;
recording a second rotation angle difference Δφ2 of the traction sheave 33 or said one individual wheel; and
b) calculating the rope stiffness EA based on at least said first and second measurements in at least two different vertical positions L1, L2, Ln;
c) indicating rope condition based on changed rope stiffness EA.

To increase measurement accuracy it is preferred that T1 and T2 are significantly different. For example, car could be empty or loaded with rated load.

The rope stiffness EA (E-modulus×Area) may be obtained from equations:

$$[ \begin{matrix}{C}_{1} \\ {C}_{2}\end{matrix} ] = \frac{R}{Δ {Fr}^{2} ( {L}_{1} - {L}_{2} )} [ \begin{matrix}- {L}_{2} & {L}_{1} \\ 1 & - 1\end{matrix} ] [ \begin{matrix}{Δφ}_{1} \\ {Δφ}_{2}\end{matrix} ] , \qquad ( 1 )$$

where
C₁ is the combined elasticity of springs in the elevator system (rope fixing springs, motor fixing, platform springs)
C₂ is the elasticity of ropes
R is the traction sheave radius
ΔF is the change in total suspension rope force on car side after opening the machine brake or the safety gear
r is reeving ratio, and

$$EA = \frac{1}{{C}_{2} {rn}_{sr}} , \qquad ( 2 )$$

where nₛᵣ is the amount of suspension ropes.

The rope stiffness can be calculated from equations (1) and (2) regardless of whether the device to hold the car in place (parking brake 12 or safety gear 11) is fixed to the car 2 or sling 6.

In an embodiment the method comprises predicting remaining rope lifetime based on changed rope stiffness.

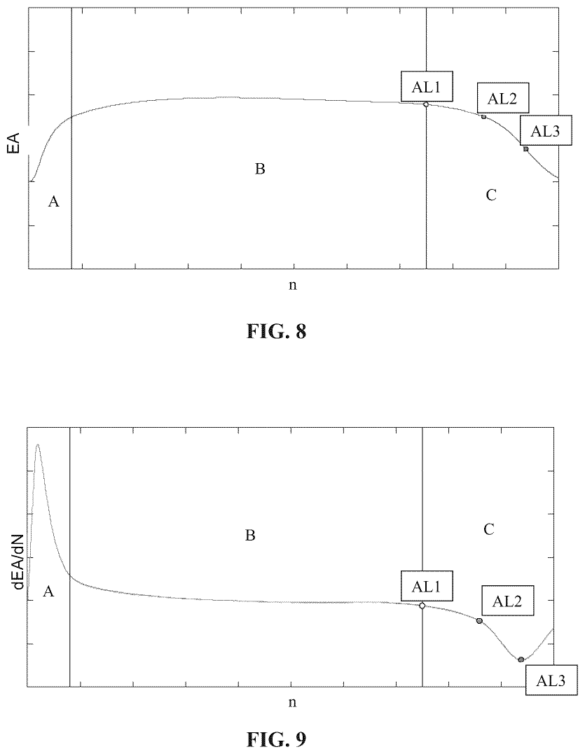

FIG. 8 illustrates how rope stiffness changes during lifetime.

FIG. 9 illustrates the slope of stiffness curve during rope lifetime.

Rope stiffness changes during lifetime as the rope is bent around pulleys. Roughly three phases can be distinguished: A: Run-in phase during which wires settle tighter against each other and rope stiffness increases rapidly, B: Usage phase during which stiffness remains almost constant, and C: Deterioration phase during which stiffness decreases due to wire breaks.

Remaining rope lifetime can be predicted on the basis of illustrated curves. In particular, one or more alarm limits AL1, AL2, AL3 that indicate the need for replacing the ropes can be defined on the basis of the curves. Rope deterioration phase C is characterized by firstly: decreased stiffness compared to usage phase (see FIG. 8), and secondly: negative slope of stiffness curve (see FIG. 9).

In an embodiment the method comprises indicating limited rope condition based on decreased rope stiffness, preferably compared to the rope stiffness during a usage phase of the ropes, more preferably when the rope stiffness has decreased by 10% compared to the usage phase.

For identifying rope deterioration the described stiffness measurement may be performed regularly and frequently. The measurement can be performed e.g. once in a week during night time when the elevator is not used. It's preferred that the measurement data is saved in a log for possible further analysis.

In an embodiment the method comprises performing said first and second measurements and calculation to obtain the rope stiffness regularly, preferably once a week.

For calculating the slope of stiffness curve as a function of bends the elevator may have a bending counter.

In an embodiment the elevator comprises means for counting rope bends such as a bending counter, and the method comprises indicating rope deterioration when rope stiffness with respect to rope bends decreases, preferably when a slope of a rope stiffness curve has been negative for 50 000rope bends.

In an embodiment the method comprises indicating need for replacing the ropes 4 or the rope on one said individual wheel based on decreased rope stiffness.

In an embodiment the elevator comprises a parking brake 12 in the car for locking the car vertically immobile.

In an embodiment the car 2 is parked by closing the parking brake 12 of the car 2.

In an embodiment the elevator comprises a safety gear 11 in the car 2 for locking the car vertically immobile.

In an embodiment the car 2 is parked by closing the safety gear 11 in the car.

A bi-directional safety gear is able to hold the car in both directions, so the car load can be more or less than the elevator balance load. With ordinary safety gear the car load must be more than the elevator balance load. Safety gear has clearances, which affects traction sheave rotation angle when the machine brake is opened. However, the effect of clearances is cancelled from results when the measurement is done in two or more vertical positions such as landings.

In an embodiment the method comprises performing the enabling the traction sheave 33 to rotate by opening the machine brake 34.

In an embodiment the first position L1 in the shaft 1 is a landing.

To increase measurement accuracy it's preferred that L1 and L2 are significantly different. For example, the measurement could be done in the bottom floor and in the top floor. Measurement could also be done in more than two floors to increase accuracy and reliability.

In an embodiment the second position L2 in the shaft 1 is a different landing from the landing in the first position L1.

In an embodiment the second position L2 in the shaft 1 differs vertically from the first position L1.

In an embodiment the first position L1 in the shaft 1 is the top landing.

In an embodiment the first position L1 in the shaft 1 is the bottom landing.

In an embodiment the first measurement is performed while the car is parked in the bottom landing and the second measurement is performed while the car is parked in the top landing, or respectively, the first measurement is performed while the car is parked in the top landing and the second measurement is performed while the car is parked in the bottom landing.

In an embodiment the method comprises at least one further measurement step:
parking the car 2 to a further position Ln (rope length Ln when the car is in the further position) in the shaft 1, in which position a total rope force on car side T1 is selected different from total rope force on counterweight side T2, and locking the car vertically immobile in place relative the shaft;
enabling the traction sheave 33 or one said individual wheel to rotate to the direction of larger rope force T1, T2;
recording a further rotation angle difference Δφn of the traction sheave 33 or said one individual wheel;
calculating the rope stiffness EA based on the measurements on different vertical positions.

In an embodiment the further position Ln in the shaft 1 is a landing.

It is possible to obtain rope stiffness as a function of length by performing the measurement in steps across the whole travel height. In an embodiment the method comprises performing a series of measurements steps across the whole travel height of the car e.g. in 5 m steps. This way it is possible to identify even short, damaged parts in a long rope, which would otherwise be hidden. Resolution of this type of measurement depends on the measurement interval.

In an embodiment the elevator comprises means for counting rope bends such as a bending counter, and for indicating rope deterioration when rope stiffness with respect to rope bends decreases.

The method may base on real, measured elasticity of the elevator in question. If the absolute value of rope stiffness is to be calculated, following prerequisites are required: car mass M_{car} and counterweight mass M_{CWT}, or alternatively rated load Q and balancing percentage p; traction sheave radius R; reeving ratio r; number of suspension ropes nₛᵣ.

If only the relative change of rope stiffness is to be calculated, the prerequisites are not needed.

Rope lengths L1 and L2 and traction sheave rotation angles ΔΔ1 and Δφ2 may be measured with existing sensors (e.g. car encoder and motor encoder) and read from the elevator control system.

In an embodiment the method comprises recording the first and second rotation angle difference Δφ1, Δφ2, . . . , ΔΔn by an elevator sensor such as a car encoder or a motor encoder.

In an embodiment the method comprises recording the car position L1, L2, . . . , Ln by an elevator sensor such as a car encoder or a motor encoder or unique magnets per landing or unique RFID tags per landing.

In an embodiment the ropes are configured to stay in place relative to the traction wheel during the measurement steps. Slip of the ropes should not happen because T1/T2 ratio approaches 1 when the machine brake 34 is opened.

Traction sheave radius R may change during elevator lifetime due to wear. However, the change is typically only a few per mil which doesn't significantly affect the method. In some embodiments a coated rope is used as the suspension rope. The coating of the coated rope may change during elevator lifetime due to wear. However, the change is typically minor and doesn't significantly affect the method.

The parking brake 12 is typically designed to hold the whole rated load Q. Since the unbalance between car and counterweight is always less than the rated load (e.g. 50% of Q) the parking brake should easily hold the unbalance used in the method.

Rope masses, travelling cable mass, guide friction and pulley bearing friction have been ignored in the described method.

Constant C₁ is the combined elasticity of springs in the elevator system. The change of this constant may be used as an indicator for condition of springs.

The method can be used to measure the average stiffness of all suspension ropes.

The stiffness of separate individual suspension ropes 4 may be measured if there are separately bearing-mounted wheels of the traction sheave 33 for each suspension rope in case the suspension is 1:1, and further if there are separately bearing-mounted diverting pulleys for each suspension rope in case the suspension is _{2:1.}

This may be done by rotating one wheel of the multi wheel traction sheave at a time and measuring the angle of rotation, i.e. the traveling length the rope in question. Respectively, measuring the change in force of said rope with a force sensor gives the force and displacement for that rope and allows the stiffness to be calculated for that rope. Said change in force of said rope may be measured using a compensating device for equalizing and/or compensating the rope tension, the compensating device comprising force sensors at car side. Each respective wheel may be rotated by motor or said respective wheel may be coupled to rotate freely.

This allows the ropes to be examined separately, giving better resolution. The car 2 may not even need to be locked in place with the parking brake 12, as it may not move anyway if only one wheel is rotated at a time.

The use of the invention is not limited to the elevator disclosed in the figures. The invention can be used in any type of elevator e.g. an elevator comprising a machine room or lacking a machine room, an elevator comprising a counterweight or lacking a counterweight. The counterweight could be positioned on either side wall or on both side walls or on the back wall of the elevator shaft. The drive, the motor, the traction sheave, and the machine brake could be positioned in a machine room or somewhere in the elevator shaft. The elevator car guide rails could be positioned on opposite side walls of the shaft or on a back wall of the shaft.

It will be obvious to a person skilled in the art that, as the technology advances, the inventive concept can be implemented in various ways. The invention and its embodiments are not limited to the examples described above but may vary within the scope of the claims.

1. A method for monitoring elevator suspension rope condition, the elevator comprising:
a car; a hoisting machinery with a motor, a traction sheave and a machine brake; one or more suspension ropes; and a counterweight;
the car and the counterweight being suspended by said one or more ropes which are guided over a unitary traction sheave or a group of rotatable individual wheels comprised by the traction sheave for moving the car vertically in an elevator shaft;
the method comprising
a) performing consecutive first and second measurement steps, wherein in the first measurement step:
parking the car to a first position in the shaft, in which position a total rope force on car side is selected different from a total rope force on counterweight side, and locking the car vertically immobile in place relative the shaft;
enabling the traction sheave or one of the individual wheels to rotate to the direction of larger rope force;
recording a first rotation angle difference (Δφ1) of the traction sheave or said one individual wheel; and
in the second measurement step:
parking the car to a second position in the shaft, in which position a total rope force on car side is selected different from total rope force on counterweight side, and locking the car vertically immobile in place relative the shaft;
enabling the traction sheave or said one individual wheel to rotate to the direction of larger rope force;
recording a second rotation angle difference (Δφ2) of the traction sheave or said one individual wheel; and
b) calculating the rope stiffness based on at least said first and second measurements in at least two different vertical positions;
c) indicating rope condition based on changed rope stiffness.

2. The method according to claim 1, comprising predicting remaining rope lifetime based on changed rope stiffness, and/or
comprising indicating need for replacing the ropes or the rope on one said individual wheel based on decreased rope stiffness.

3. The method according to claim 1, comprising indicating limited rope condition based on decreased rope stiffness, preferably compared to the rope stiffness during a usage phase of the ropes, more preferably when the rope stiffness has decreased by 10% compared to the usage phase.

4. The method according to claim 1, wherein the elevator comprises means for counting rope bends such as a bending counter, the method comprising indicating rope deterioration when rope stiffness with respect to rope bends decreases, preferably when a slope of a rope stiffness curve has been negative for 50 000 rope bends.

5. The method according to claim 1, comprising performing said first and second measurements and calculation to obtain the rope stiffness regularly, preferably once a week.

6. The method according to claim 1, comprising performing the parking of the car by closing a parking brake of the car, and/or
comprising performing the parking of the car by closing a safety gear in the car, and/or
comprising performing the enabling the traction sheave to rotate by opening the machine brake.

7. The method according to claim 1, wherein the first position in the shaft is a landing, and preferably wherein the second position in the shaft is a different landing from the landing in the first position; and/or
wherein the second position in the shaft differs vertically from the first position.

8. The method according to claim 1, comprising at least one further measurement step:
parking the car to a further position in the shaft, in which position a total rope force on car side is selected different from total rope force on counterweight side, and locking the car vertically immobile in place relative the shaft;
enabling the traction sheave or one said individual wheel to rotate to the direction of larger rope force;
recording a further rotation angle difference (Δφn) of the traction sheave or said one individual wheel;
calculating the rope stiffness based on the measurements on different vertical positions.

9. The method according to claim 1, comprising recording the car position by an elevator sensor such as a car encoder or a motor encoder or unique magnets per landing or unique RFID tags per landing.

10. An arrangement for monitoring elevator suspension rope condition, the arrangement comprising
an elevator comprising a car; a hoisting machinery with a motor, a traction sheave and a machine brake; one or more suspension ropes;
and a counterweight;
the car and the counterweight being suspended by said one or more ropes which are guided over a unitary traction sheave or a group of rotatable individual wheels comprised by the traction sheave for moving the car vertically in an elevator shaft;
the arrangement further comprising means for
a) performing consecutive first and second measurement steps, wherein in the first measurement step:
the car is parked to a first position in the shaft, in which position a total rope force on car side is selected different from a total rope force on counterweight side, and the car is locked vertically immobile in place relative the shaft;
the traction sheave or the individual wheel is enabled to rotate to the direction of larger rope force;
a first rotation angle difference (Δφ1) of the traction sheave or one said individual wheel is recorded; and
in the second measurement step:
the car is parked to a second position in the shaft, in which position a total rope force on car side is selected different from total rope force on counterweight side, and the car is locked vertically immobile in place relative the shaft;
the traction sheave or said one individual wheel is enabled to rotate to the direction of larger rope force;
a second rotation angle difference (Δφ2) of the traction sheave or said one individual wheel is recorded; and
b) calculating the rope stiffness based on at least said first and second measurements in at least two different vertical positions;
c) indicating rope condition based on changed rope stiffness.

11. The arrangement according to claim 10, comprising means for indicating need for replacing the ropes or the rope on one said individual wheel based on decreased rope stiffness, and/or
comprising means for indicating limited rope condition based on decreased rope stiffness.

12. The arrangement according to claim 10, wherein the elevator comprises means for counting rope bends such as a bending counter, and for indicating rope deterioration when rope stiffness with respect to rope bends decreases, and/or
wherein the elevator comprises a parking brake in the car for locking the car vertically immobile, and/or
wherein the elevator comprises a safety gear in the car for locking the car vertically immobile.

13. The arrangement according to claim 10, wherein the first position in the shaft is a landing, and/or
wherein the second position in the shaft differs vertically from the first position.

14. The arrangement according to claim 10, comprising an elevator sensor such as a car encoder or a motor encoder for recording the first and second rotation angle difference (Δφ1, Δφ2, . . . , Δφn), and/or
comprising an elevator sensor such as a car encoder or a motor encoder or unique magnets per landing or unique RFID tags per landing for recording the car position.

15. The arrangement according to claim 10, wherein the ropes are configured to stay in place relative to the traction wheel during the measurement steps.
